(19) United States
(12) Patent Application Publication
(10) Pub. No.: US 2019/0112054 A1
(43) Pub. Date: Apr. 18, 2019

(54) INTEGRATED ICE PROTECTION AND LIGHTNING STRIKE PREVENTION

(71) Applicant: Goodrich Corporation, Charlotte, NC (US)

(72) Inventors: Wenping Zhao, Glastonbury, CT (US); Zaffir A. Chaudhry, S. Glastonbury, CT (US); Galdemir Cezar Botura, Akron, OH (US)

(21) Appl. No.: 15/787,341

(22) Filed: Oct. 18, 2017

(51) Int. Cl. B64D 15/12; H02H 1/04; B64D 45/02; H05B 3/14; H05B 3/34

(52) U.S. Cl. CPC B64D 15/12; H02H 1/04; B64D 45/02; H05B 2214/04; H05B 3/34; H05B 2203/017; H05B 3/145

(57) ABSTRACT

A heater assembly includes both a carbon allotrope heating element for ice protection and a metallic carrier material for lightning strike damaged protection. The carbon allotrope heating element is formed on the metallic carrier material to create an integrated heating and lighting protection assembly.

### BACKGROUND

This application relates generally to aircraft ice and lightning protection, and specifically to ice and lightning protection materials.

Exterior surfaces of aircraft are often subjected to ice formation, and anti-icing or de-icing devices must be used to remove or prevent ice from accumulating. Various types of ice protection systems have been developed to protect aircraft from the hazardous effects of icing, including bleed air, electro-thermal, and pneumatic boot de-icing systems. Electro-thermal de-icing systems typically use metal wires to resistively melt ice by converting electrical energy to thermal energy. The use of metal wires as resistance elements embedded in de-icing systems presents several problems, including element durability, parasitic weight, limited damage tolerance and low power efficiency.

Additionally, exterior surfaces of aircraft are subject to lightning strikes which can heavily damage aircraft surfaces and parts. Typically, aircrafts use mesh or grid materials to diffuse lightning strikes along the external surfaces of an aircraft. However, these grids add weight to the external surface of an aircraft.

Carbon nanotube (CNT) materials have been proposed as an alternative to metal wire or foil heating elements in ice protection systems. CNTs are carbon allotropes having a generally cylindrical nanostructure. They have unusual properties that make them valuable for many different technologies. For instance, some CNTs can have high thermal and electrical conductivity, making them suitable for replacing metal heating elements. Due to their much lighter mass, substituting CNTs for metal heating components can reduce the overall weight of a heating component significantly. However, while CNT materials are available in flat sheets or films, they are not easily conformed to complex shapes or structures. Additionally, CNT sheets are difficult to integrate with many components.

### SUMMARY

In one embodiment, a heater assembly extending a thickness from a bond side to a breeze side includes a carbon allotrope heating element, and a carrier material capable of preventing lightning strike damage attached to the carbon allotrope heating material opposite the bond side.

In another embodiment, a method of making a heater assembly includes adding an isolation layer on a carrier material capable of lightning strike damage protection, and forming a carbon allotrope heating element on the isolation layer opposite the carrier material.

### BRIEF DESCRIPTION OF THE DRAWINGS

FIG. 1 is a schematic drawings of an ice protection and lightning strike prevention assembly.

FIG. 2 is a flow chart depicting a method of making an ice protection and lightning strike prevention assembly.

### DETAILED DESCRIPTION

Manufacturing a carbon nanotube (CNT) heater assembly with a preformed carrier allows for the creation of complex shaped or structured CNT heaters. If the preformed carrier is a highly electrically conductive carrier, and is integrated onto an aircraft component, for example, a blade or aircraft wing leading edge, the finished heater assembly can be used both for ice protection and lightning strike prevention.

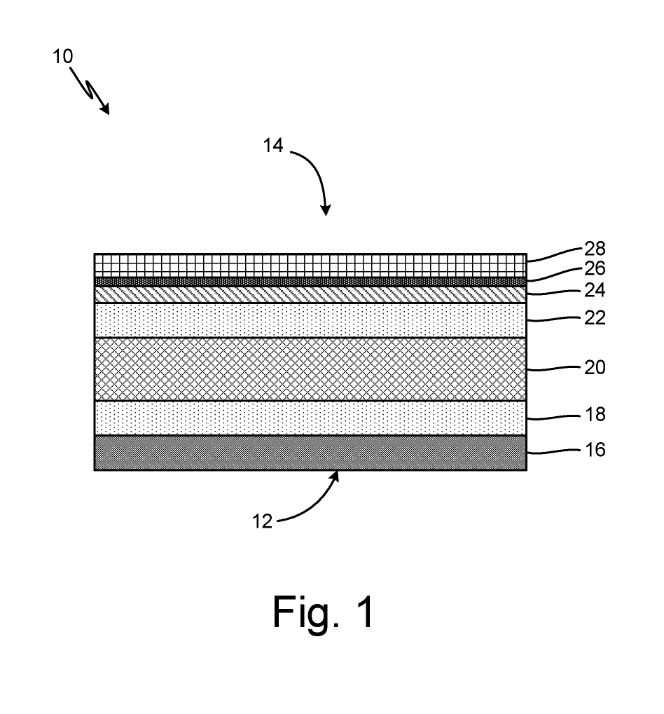

FIG. 1 is a schematic drawings of ice protection and lightning strike prevention assembly 10. Assembly 10 has bond side 12 (contacting the airfoil or other aircraft part) and breeze side 14 (contacting external component). Assembly 10 contains, from bond side 12 to breeze side 14, first electrical isolation layer 16, first adhesive 18, heater 20, second adhesive 22, second electrical isolation layer 24, third adhesive 26, and mesh 28.

First electrical isolation layer 16 and first adhesive 18 on bond side 12 anchor assembly 10 to an aircraft surface needing ice and lightning protection. First electrical isolation layer 16 and first adhesive 18 adhere heater 20 to bond side 12 and an airfoil (not shown) or other aircraft part upon which assembly 10 is situated. First electrical isolation layer 16 can be a pre-impregnated (“pre-preg”) fabric, such as a fiberglass pre-preg, or other appropriate material to isolate heater 20 to bond side 12. First adhesive 18 can be an epoxy, a film adhesive, or other suitable adhesive to secure heater 20 to first electrical isolation layer 16.

Heater 20 is a thermally conductive heating element that provides heat to surfaces of aircraft needing ice protection. Heater 20 can be a carbon allotrope heater, such as carbon nanotubes, graphene, graphene nanoribbons (GNRs), graphite or other suitably conductive form of carbon. Heater 20 can be woven or non-woven, knitted, braided, self-assembled, vapor deposited, solution cast, planar or nonplanar, or three dimensional. Alternatively, heater 20 can be a pre-preg carbon sheet, depending on ice protection needs. Heater 20 is thermally conductive and can heat breeze side 14 of assembly 10 such that ice melts or is prevented from forming on the aircraft.

Second electrical isolation layer 24 can be a pre-preg layer, such as a fiberglass pre-preg, or other appropriate material. Second electrical isolation layer 24 is attached between heater 20 and mesh 28 to electrically isolate heater 20 when mesh 28 is struck by lightning.

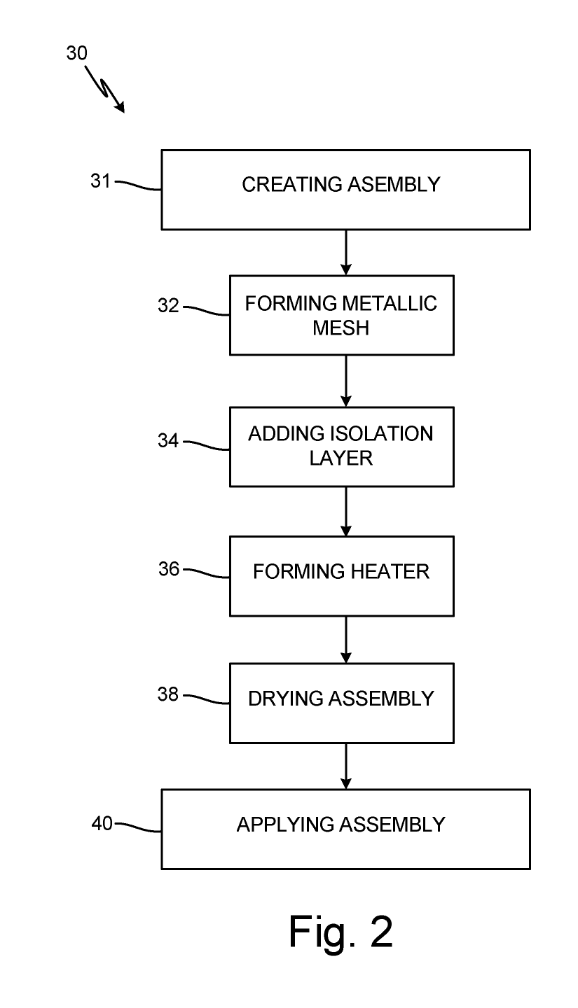

Mesh 28 is an electrically conductive lightning attraction element that diffuses lightning strikes and prevents lightning strike damage on an aircraft. Third adhesive 26 secures mesh 24 to second electrical isolation layer 26 opposite heater 20. Third adhesive 26 can be epoxy, a film adhesive, or other suitable adhesive. Mesh 28 can be copper, aluminum, or other suitable metallic material. Mesh 28 is a lighting carrier that absorbs lightning strikes on the aircraft and diffuses energy of the lightning so that underlying airfoils, wires, and other aircraft parts are not affected by the lightning strike. Attachment of mesh 28 to heater 20 is discussed in more detail with reference to FIG. 2 below.

With mesh 28 and heater 20, ice protection and lightning strike prevention can be tailored across the external surfaces of the aircraft. Depending on each particular surface, its likelihood of being struck by lightning, and potential ice build-up, varying amounts and shapes of assembly 10 can be applied. For instance, assembly 10 can be shaped and applied to leading edges of airfoils, wings, propellers, or other zones that typically take lightning strikes while in flight.

FIG. 2 is a flow chart depicting method 30 of making an ice protection and lightning strike prevention assembly. Method 30 includes assembly steps 32-38 and application step 40. In method 30, the lightning strike damaged prevention portion of assembly is formed first. A metallic mesh is formed (step 32) in a typical manufacturing process. The metallic mesh is formed into the desired final structure or shape. The mesh can be copper, copper alloys, aluminum, aluminum alloys, or other suitable metals. Next, in step 34, an electrical isolation layer (layer 26 in FIG. 1) is formed on the metallic mesh. The electrical isolation layer can, for example, be an electrical isolation layer capable of electrically isolating the metallic mesh layer.

Next, in step 36, the heater layer is formed on the isolation layer. Here, the metallic mesh acts as a carrying material for the carbon allotrope heater. The heater can be, for example, a CNT heater. If CNT is used, the CNT heater can be a commercially available flat CNT sheet or film. These sheets or films can be embedded into aircraft structures for ice protection or heating needs. However, it is difficult to reconfigure these sheets into complex shapes or structures. Thus, the CNT sheet (or other heater material) is embedded on a carrier material, such as the metallic mesh, suitable for preventing lightning strike damage. The mesh, isolation layer, and CNT heater assembly can then be cured or bonded and applied to an aircraft surface in step 38. Alternatively, the CNT heater, electrical isolation layers, and metallic mesh can be bonded together first and then formed into a final shape.

In step 40, the assembly from steps 32-38 is applied to an aircraft surface. The assembly can be bonded to an airfoil, wing, propeller, or other aircraft part requiring both ice protection and lightning strike damage protection. The application of the assembly can be tailored to specific aircraft ice and lightning protection needs. For example, the mesh can be shaped to fit the curvature of the aircraft part to which the assembly will be applied, and the CNT heater can be formed onto such a curved shape in step 36.

Assembly 10 of FIG. 1 and made in method 30 of FIG. 2 integrates two critical functions: ice protection and lightning strike damage prevention. By integrating these two purposes, the assembly solves two problems in a lighter weight assembly that can be tailored to aircraft zone needs. Additionally, the assembly is rigid and had increased durability compared individual lightning or ice protection assemblies.

Discussion of Possible Embodiments

The following are non-exclusive descriptions of possible embodiments of the present invention.

In one embodiment, a heater assembly extending a thickness from a bond side to a breeze side includes a carbon allotrope heating element, and a carrier material capable of preventing lightning strike damage attached to the carbon allotrope heating material opposite the bond side.

The heater assembly of the preceding paragraph can optionally include, additionally and/or alternatively, any one or more of the following features, configurations and/or additional components:

The assembly includes a first electrical isolation material on the bond side attached to the carbon allotrope heater opposite the carrier material.

The first electrical isolation material is bonded to the carbon allotrope heater by an adhesive.

The assembly includes a second electrical isolation material on the breeze side attached to the carrier material opposite the carbon allotrope heater.

The second electrical isolation material comprises a pre-impregnated material.

The carbon allotrope heating element is made from a material selected from the group consisting of carbon nanotubes, graphene, graphene nanoribbons, and graphite.

The carbon allotrope heating element is a film, sheet, curved sheet, or three dimensional shape.

The carrier material is a mesh.

The carrier material is selected from the group consisting of copper, copper alloys, aluminum, aluminum alloys, and combinations thereof.

The carbon allotrope heating element is bonded to the carrier material with an adhesive.

In another embodiment, a method of making a heater assembly includes adding an isolation layer on a carrier material capable of lightning strike damage protection, and forming a carbon allotrope heating element on the isolation layer opposite the carrier material.

The method of the preceding paragraph can optionally include, additionally and/or alternatively, any one or more of the following features, configurations and/or additional components:

The method includes curing the assembly.

The method includes applying the assembly to an aircraft surface in need of ice protection.

Obtaining a carrier material comprising forming a metallic mesh.

The metallic mesh is made of copper, copper alloys, aluminum, aluminum alloys, or combinations thereof.

Adding an isolation layer comprises bonding a pre-impregnated layer to the carrier material.

Forming a carbon allotrope heating element comprises bonding a carbon allotrope sheet to the isolation layer with an adhesive.

The carbon allotrope is selected from the group consisting of carbon nanotubes, graphene, graphene nanoribbons, and graphite.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heater assembly extending a thickness from a bond side to a breeze side comprising:
a carbon allotrope heating element; and
a carrier material capable of preventing lightning strike damage attached to the carbon allotrope heating material opposite the bond side.

2. The assembly of claim 1, further comprising a first electrical isolation material on the bond side attached to the carbon allotrope heater opposite the carrier material.

3. The assembly of claim 2, wherein the first electrical isolation material is bonded to the carbon allotrope heater by an adhesive.

4. The assembly of claim 1, further comprising a second electrical isolation material on the breeze side attached to the carrier material opposite the carbon allotrope heater.

5. The assembly of claim 4, wherein the second electrical isolation material comprises a pre-impregnated material.

6. The assembly of claim 1, wherein the carbon allotrope heating element is made from a material selected from the group consisting of carbon nanotubes, graphene, graphene nanoribbons, and graphite.

7. The assembly of claim 1, wherein the carbon allotrope heating element is a film, sheet, curved sheet, or three dimensional shape.

8. The assembly of claim 1, wherein the carrier material is a mesh.

9. The assembly of claim 1, wherein the carrier material is selected from the group consisting of copper, copper alloys, aluminum, aluminum alloys, and combinations thereof.

10. The assembly of claim 1, wherein the carbon allotrope heating element is bonded to the carrier material with an adhesive.

11. A method of making a heater assembly comprising:
adding an isolation layer on a carrier material capable of lightning strike damage protection; and
forming a carbon allotrope heating element on the isolation layer opposite the carrier material.

12. The method of claim 11, further comprising curing the assembly.

13. The method of claim 11, further comprising applying the assembly to an aircraft surface in need of ice protection.

14. The method of claim 11, wherein obtaining a carrier material comprising forming a metallic mesh.

15. The method of claim 14, wherein the metallic mesh is made of copper, copper alloys, aluminum, aluminum alloys, or combinations thereof.

16. The method of claim 11, wherein adding an isolation layer comprises bonding a pre-impregnated layer to the carrier material.

17. The method of claim 11, wherein forming a carbon allotrope heating element comprises bonding a carbon allotrope sheet to the isolation layer with an adhesive.

18. The method of claim 11, wherein the carbon allotrope is selected from the group consisting of carbon nanotubes, graphene, graphene nanoribbons, and graphite.
